(19) United States
(12) Patent Application Publication
(10) Pub. No.: US 2008/0017623 A1
(43) Pub. Date: Jan. 24, 2008

(54) Ohmic heating systems with circulation by worm

(75) Inventor: Guillaume Dock, Caumont sur Durance (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Campbell France S.A.S., a corporation of France, Le Pontet (FR)

(21) Appl. No.: 11/827,891

(22) Filed: Jul. 13, 2007

(30) Foreign Application Priority Data
Jul. 24, 2006 (FR) FR 06/06761

(51) Int. Cl. H05B 3/02

(52) U.S. Cl. 219/201

(57) ABSTRACT

An installation for heating products, in particular, a food composition formed from a heterogeneous mixture of a liquid phase and solid particles, including at least one heating pipe of tubular cross-section, the heating installation being supplied by a feed pump opening directly into the heating tube and driven by a first motor. The heating tube includes a worm that consists of a non-conductive material and is driven by a second motor controlled to provide a flow rate in the heating chamber.

### RELATED APPLICATION

This application claims priority of French Patent Application No. 06/06761, filed Jul. 24, 2006, herein incorporated by reference.

### TECHNICAL FIELD

This disclosure relates to devices for ohmic heating of food compositions, in particular soups.

### BACKGROUND

In the food processing industry, ohmic heating is well-developed as regards the heating of liquid or solid foods. This is because this technique allows a rapid temperature rise preserving the organoleptic qualities of the foods. Ohmic heating can be used for sterilizing foods.

Ohmic heating allows heating of foods by the flow of an electric current. The resistance of the product to the circulation of electricity causes raising of the temperature.

This technique of heating by Joule effect is well known. Thus, ohmic heating devices are known and comprise a tubular central duct at the two ends of which electrodes are placed, with holes to allow the introduction of a fluid into the tube and its collection. The columns used in general consist of a tube made of insulating material (Pyrex glass or plastic) in which the product to be heated circulates between the two electrodes. These two electrodes are perpendicular to both the duct and the general direction of flow of the fluid.

By way of example, JP 2004-290094 describes an installation for sterilizing food products comprising a first preheating tube, supplied by a pump, the output of this first preheating tube opening into a second ohmic heating tube.

One of the problems encountered in the use of ohmic heating for the heat treatment of foods with large pieces, such as stews or ready-made meals, is the heterogeneity of the heating of the compounds contained in the food product resulting in an overcooking of some compounds to the detriment of their organoleptic qualities.

This heating heterogeneity is related in part to a difference in the transit time of the liquid phase and the particles in the ohmic heating column. Control over the transit time of the compounds in the ohmic heating column requires control over the flow of the foods in the column.

In the aforementioned solution, the liquid phase moves more quickly than the solid particles in the first tube, then in the intermediate tubing, and then in the second tube. To take account of this phenomenon, it is necessary to set the heating time in the second tube at a duration set according to the speed of movement of the fastest phase in all the items of equipment comprising the first tube, the connecting conduit and the second tube, and therefore overheat the liquid phase. This makes it possible to guarantee the sterilization of the phase moving most quickly in the whole of the installation. However, this is done to the detriment of preservation of the nutritional and organoleptic qualities of the slowest phase.

Furthermore, after preheating, the two phases enter the sterilization tube at different temperatures, which worsens the aforementioned phenomenon.

The difference in transit time is explained on the one hand by a sedimentation problem, accentuated by a low viscosity of the liquid phase. Therefore, until very recently, the majority of known ohmic heating columns were vertical with a large cross-section. Several equipment manufacturers have recently put on the market heating columns that are horizontal with a very slight upward slope in the direction of the flow to limit the sedimentation phenomenon.

Even though these improvements have made it possible to avoid the phenomena of vertical sedimentation of pieces in the liquid phase, a heterogeneity of the transit times of the different components in the heating columns is still observed and can be explained by fluid mechanics phenomena.

In fact, the dispersion of the transit times can be linked to a laminar flow of the product. A liquid product under laminar conditions has a transit time dispersion that may reach 2 in Newtonian liquids. This is because the product in contact with the walls has an almost zero speed whereas that at the heart of the stream can go twice as fast as the average flow rate of the liquid. This phenomenon in the food compositions formed from a heterogeneous mixture of a liquid phase and solid particles is greatly limited on account of the large content of pieces in the products to be treated. This is then close to a so-called “piston flow.”

The second fluid mechanics phenomenon is “slip velocity.” In a suspension of pieces, the carrier liquid has a tendency to go faster than the pieces it is conveying. This phenomenon leads to an average time of presence of the pieces which is greater than that of the liquid.

It could therefore be advantageous to allow heating of a continuous flow of product, to make the transit time of the compounds of the food product uniform and to preserve the organoleptic qualities of the products heated by an ohmic heating column.

### SUMMARY

I provide an installation for ohmic heating a food composition formed from a heterogeneous mixture of a liquid phase and solid particles including at least one heating pipe of substantially tubular cross-section made from electrically insulating materials and including a worm made from a non-conductive material, driven by a second motor controlled to provide a flow rate in a heating chamber in the heating tube; a substantially annular electrode at each end portion of the heating pipe; an electrical power source connected to the two electrodes; and a feed pump driven by a first motor and supplying heating installation and opening directly into the heating tube.

### BRIEF DESCRIPTION OF THE DRAWING

My systems will be better understood from a reading of the following description, referring to the accompanying drawings concerning non-limiting, representative examples where:

FIG. 1 depicts a schematic view of a heating installation.

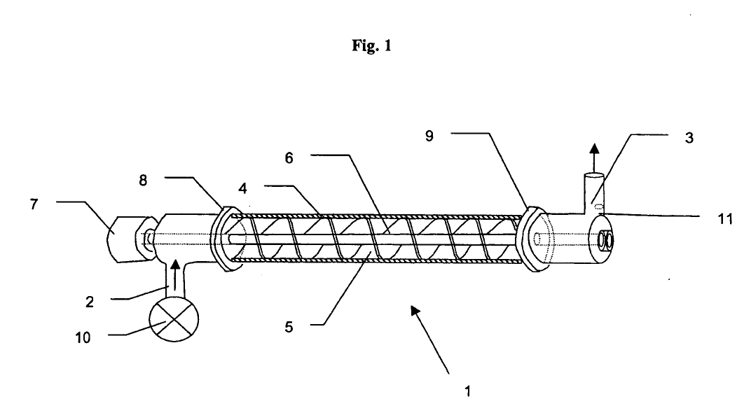

### DETAILED DESCRIPTION

It will be appreciated that the following description is intended to refer to specific examples of structure selected for illustration in the drawings and is not intended to define or limit the disclosure, other than in the appended claims.

I provide an installation for heating products, in particular, a food composition formed from a heterogeneous mixture of a liquid phase and solid particles, comprising at least one heating pipe of substantially tubular cross-section made from electrically insulating materials and having at its two end portions an annular electrode, the two electrodes being connected to an electrical power source, the heating installation being supplied by a feed pump driven by a first motor, wherein the feed pump opens directly into the heating tube, the heating tube comprising a worm of a non-conductive material, driven by a second motor controlled to provide a flow rate in the heating chamber.

The worm may be provided with a solid core serving as an axis of rotation. The pitch of the worm may be greater than twice the size of the side of the largest pieces. The motor of the worm may be provided with a frequency converter to vary its rotation speed.

The worm may be made from a non-abrasive plastic material. The food product may have a viscosity of between about 250 and about 1500 millipascal/second. The food product may also have a particle content of between about 30% and about 80%.

The food product may further have a uniform conductivity comprising a difference between the liquid phase and the particles of 1 to 3.

Turning now to the Drawing, the heating installation includes a hollow tube (1) made from an insulating material having at one of its ends a supply conduit (2) opening radially into the tube (1), and at the other end by a conduit (3) for output of the heated product. The cross-section of the supply conduits and of the tube is determined to allow a slow passage through the installation, preserving the different solid constituents.

The tube (1) encloses a worm (4) having a helical flute (5) surrounding a tubular core (6).

The core (6) is driven by a motor (7) driving the worm rotationally. This motor is controlled by a frequency converter to allow an adjustment of the speed of rotation of the worm and feedback control as a function of temperature variations measured at the output of the tube, and possibly other parameters coming from sensors installed on the sterilization chain.

Annular electrodes (8, 9) are provided upstream and downstream of the worm to produce ohmic heating of the materials introduced into the tube.

These materials are introduced into the tube by a feed pump (10) whereof the flow rate is determined to provide regular filling of the worm. The feed pump (10) is connected directly to the ohmic heating tube to avoid any pressure drop between the pump and the worm. The drive motor for the pump (10) and the drive motor (7) for the worm (4) are controlled synchronously by a regulating circuit to provide a regular feed and a constant flow rate inside the tube (1).

The consecutive segment of helical flutes forms a longitudinal partitioning of the tube. This partitioning limits the differences in speed of movement of the different constituents of a heterogeneous mixture introduced into the tube. The fastest particles have an average speed of movement substantially equal to the average speed of the slowest particles, the variations being limited by the presence of two consecutive segments of the worm.

Therefore, the heating, which is a function of the strength of the current, the resistance of the compound and the transit time in the tube, is substantially constant irrespective of the nature of the constituents.

The tube comprises a temperature probe (11) placed in proximity to the output of the tube, issuing an electrical signal used by a regulating circuit controlling the speed of movement of the worm.

By way of example, the diameter of the tube is 125 millimeters. The pitch of the helical flute is 100 millimeters. It is a function of the size of the solid pieces present in the mixture to be sterilized. Optimally, the pitch is greater than 2 L, where L defines the length of the largest piece. The pitch is preferentially between 2 L and 4 L.

Power for the electrodes is provided by an alternating current having a frequency of about 15 kHz to about 30 kHz and a voltage between about 1500 and about 5000 volts per meter. The operating range is between about 20° C. and about 155° C.

The worm is made from a non-abrasive plastic material.

Several tubes can be used in series to carry out, for example, a sterilization in temperature stages.

The sterilized product is then cooled to a temperature of about 40° C. by passage through a cold water heat exchanger.

The food product to be sterilized in such an installation has a viscosity of between about 250 and about 1500 millipascal/second. The particle content is between about 30% and about 80%.

The conductivity is preferably less that about 10 milliSiemens/centimeter and greater than about 0.01 milliSiemens/centimeter at 25° C.

In the case of meat pieces, the electrical conductivity is between about 1 milliSiemen/centimeter and about 7 milliSiemens/centimeter.

Although the apparatus and methods have been described in connection with specific forms thereof, it will be appreciated that a wide variety of equivalents may be substituted for the specified elements described herein without departing from the spirit and scope of this disclosure as described in the appended claims.

1. An installation for ohmic heating a food composition formed from a heterogeneous mixture of a liquid phase and solid particles, comprising: at least one heating pipe of substantially tubular cross-section made from electrically insulating materials and comprising a worm made from a non-conductive material, driven by a second motor controlled to provide a flow rate in a heating chamber in the heating tube; a substantially annular electrode at each end portion of the heating pipe; an electrical power source connected to the two electrodes; and a feed pump driven by a first motor and supplying heating installation and opening directly into the heating tube.

2. The installation according to claim 1, wherein the worm is provided with a solid core serving as an axis of rotation.

3. The installation according to claim 1, wherein the heating tube is an ohmic heating tube.

4. The installation according to claim 2, wherein the worm has a pitch greater than twice the size of a side of its largest pieces.

5. The installation according to claim 1, wherein the second motor of the worm is provided with a frequency converter to vary its rotation speed.

6. The installation according to claim 1, wherein the worm comprises a non-abrasive plastic material.

7. The installation according to claim 1, wherein the food composition has a viscosity of between about 250 and about 1500 millipascal/second.

8. The installation according to claim 1, wherein the food composition has a particle content of between about 30% and about 80%.

9. The installation according to claim 1, wherein the food composition has a substantially uniform conductivity comprising a difference between the liquid phase and the particles of 1 to 3.

10. The installation according to claim 1, wherein the worm has a pitch between 2 L and 4 L, where L defines the length of the largest piece.

11. The installation according to claim 1, wherein the second motor is controlled to provide a flow rate in the heating chamber synchronous with the supply flow rate.
